(19) United States
(12) Patent Application Publication
(10) Pub. No.: US 2024/0353084 A1
(43) Pub. Date: Oct. 24, 2024

(54) IMPROVED REPLACEMENT SYSTEM FOR AN OPTICAL COMPONENT OF A LIGHTING DEVICE

(71) Applicant: SIGNIFY HOLDING B.V., EINDHOVEN (NL)

(72) Inventors: MARTON BENDEGUZ FILLINGER, ÜRÖM (HU); SOMA GABOR UNGAR, BUDAPEST (HU); HORVÁTH JÁNOS, BUDAPEST (HU); GÁBOR KISS, BUDAPEST (HU)

(21) Appl. No.: 18/686,839

(22) PCT Filed: Aug. 19, 2022
(86) PCT No.: PCT/EP2022/073187

§ 371 Date: Feb. 26, 2024

(30) Foreign Application Priority Data
Aug. 26, 2021 (EP) 21193338.7

(51) Int. Cl. F21V 17/16; F21V 17/06

(52) U.S. Cl. CPC F21V 17/164; F21V 17/06

(57) ABSTRACT

The present invention relates to an optical component holder (1) for assembling a lighting device (20), the optical component holder (1) comprising at least one flexible flap (5) being attached to an edge portion (4) extending substantially in a transversal plane. The at least one flexible flap (5) comprises a locking snap-fit arrangement (6) and a releasing portion (9). The optical component holder (1) further comprises a housing connection (10) for attaching the optical component holder (1) to the lighting device (20) and a releasing element (12) for releasing the locking element (11). The locking snap-fit arrangement (6) comprises a contact surface (6″) facing the edge portion (4). The lower portion (8) of the locking snap-fit arrangement (6) is movable between a locked position and an unlocked position in the longitudinal plane.

### TECHNICAL FIELD

The present invention relates to an optical component holder for assembling a lighting device, and a lighting device comprising such an optical component holder.

### BACKGROUND

It is commonly known that setting a correct lighting in an indoor or an outdoor environment may be of a paramount importance. For instance, it may be desirable to put an accent on a shelf in a store, or to direct a number of spotlights in different directions in a room. To this end, luminaires comprising reflectors are widely used. Such luminaires may be lighting fixtures such as downlights, spotlights, ceiling lights, and outdoor lightings. The reflector mainly serves to re-distribute light emitted by a light source.

The luminaires may have different optical components, e.g. reflectors, that are replaceable for achieving different lighting effects. However, the process of replacing such optical components is cumbersome, since the optical components are normally attached by means of a screw oftentimes being hidden from view in order to enhance the aesthetic appearance of the luminaire, and thus being rather inaccessible. Moreover, the user replacing the optical component may have to lift the arms and bend the neck in order to perform the replacement operation, which leads to pain and discomfort when the replacement operation is time-consuming. Finally, the user may need a set of tools, such as a screwdriver or the like, in order to perform the replacement.

Therefore, for a lighting device comprising components that need to be replaced on a regular basis, there is a need to provide an optical component holder that enables a simple, quick, and ergonomic replacement of optical components, preferably without needing any tools.

### SUMMARY

In view of the above discussion, the purpose of the present invention is to provide such an optical component holder.

The present invention thus provides an optical component holder for assembling a lighting device. By the term “assembling” is understood as a procedure of connecting the elements of the lighting device to each other, such that the lighting device is ready to be put in operation. The lighting device according to the present invention may be a downlight, a spotlight, a ceiling light, outdoor lighting, or the like. The lighting device according to the present invention may be suspended from a ceiling, fixedly or rotatably mounted on the ceiling or on the wall, or be attached in any other way that is known to a person skilled in the art.

According to a first aspect of the present invention, an optical component holder is provided. The optical component holder is for assembling a lighting device, said optical component holder comprises a central portion and an edge portion, at least one flexible flap, a housing connection, and a releasing element. Said edge portion delimits said central portion, and wherein said central portion and said edge portion extend substantially in a longitudinal plane. At least one flexible flap is being attached to said edge portion of said optical component holder and extending substantially in a transversal plane being substantially perpendicular to said longitudinal plane, said at least one flexible flap comprising a locking snap-fit arrangement, wherein said locking snap-fit arrangement comprises a lower portion being adjacent to said edge portion of said optical component holder, an upper portion arranged at a distance from said lower portion in said transversal plane, said locking snap-fit arrangement further comprising a releasing portion. The housing connection is being arranged for attaching said optical component holder to said lighting device, said housing connection is being attached to said edge portion of said optical component holder and extending in said transversal plane and comprising a locking element. The releasing element is accompanied with one or more ratchet surfaces that are facing away from said central portion of said optical component holder for releasing said locking element. At least one flexible flap has a lower portion of said locking snap-fit arrangement that comprises a contact surface facing said edge portion, said lower portion of said locking snap-fit arrangement further comprising a wedge element extending substantially parallelly to said longitudinal plane and facing said central portion of said optical component holder, said lower portion of said locking snap-fit arrangement being movable between a locked position and an unlocked position in said longitudinal plane, said lower portion of said locking snap-fit arrangement having a transversal cross-section being substantially parallel to said transversal plane. Said transversal cross-section of said lower portion of said locking snap-fit arrangement is substantially U-shaped. And between said contact surface and said longitudinal plane, a contact angle is created that is an acute angle.

The optical component holder of the present invention is arranged to receive and hold an optical element, such as a reflector or the like, and comprises a central portion and an edge portion, wherein the edge portion delimits the central portion, and wherein the central portion and the edge portion extend substantially in a longitudinal plane. The optical component holder may have any suitable shape and size. In particular, the optical component holder may be circular, elliptic, square, rectangular, pentagonal, or hexagonal. The longitudinal plane may be a horizontal plane, and the transversal plane may be a vertical plane. However, other spatial orientations of the longitudinal plane and the transversal plane are conceivable.

The locked position may be an inherent resting position for the locking snap-fit arrangement. The wedge element may provide the snap fit functionality of the locking snap-fit arrangement. When inserting the optical element into the optical component holder, the wedge element may move in a direction away from the central position and thereby making way for the optical element to be pushed in the direction of the edge portion of the optical component holder. Once an edge portion of the optical element makes contact with the contact surface of the optical component holder, the optical element may be presumed to be secured in a locked position which is a position where the optical element is held down on to the edge portion of the optical component holder. The contact surface may push down the optical element in the locked position. The contact angle may also provide a transversal pressure that pushes the optical component in a centralized direction.

The unlocked position may be achieved by pulling by the releasing portion in a direction substantially parallel to said longitudinal plane, but opposite to the central portion. Pulling the releasing portion in a way to move the wedge portion in the direction, thereby making room for the optical element to be inserted or removed from the optical component holder.

The central portion of the optical component holder may be constituted of an opening, and the edge portion may be constituted of a rim. Preferably, the optical component holder is substantially annular.

The central portion can be hollow, or can be considered having an opening.

The wedge element may substantially extend in a direction opposite of the releasing portion.

The releasing portion may face away from the central portion of the optical component holder.

The releasing element may be arranged on opposite sides to the housing connection.

The optical component holder according to the present invention comprises at least one flexible flap being attached to the edge portion of the optical component holder and extending substantially in a transversal plane being substantially perpendicular to the longitudinal plane. By the term “flexible” is in the context of the present invention understood as capable of being bent, especially repeatedly. The optical component holder may comprise a plurality of flexible flaps. The term “plurality” is in the context of the present invention intended to mean more than one, such as two, three, four, or five flexible flaps.

The optical component holder may comprise two flexible flaps arranged on the opposite sides of the edge portion, as will be described in greater detail below. The flexible flap may be attached to the edge portion in any suitable way, such as by welding, gluing or the like, or may be an integral part of the optical component holder.

The at least one flexible flap may comprise a locking snap-fit arrangement. The locking snap-fit arrangement is provided for releasably locking an optical element, such as a reflector, in the optical component holder. By the term “releasably locking” is understood as repeated affixing and releasing is possible. The locking snap-fit arrangement may comprise a lower portion being adjacent to the edge portion of the optical component holder, an upper portion arranged at a distance from the lower portion in the transversal plane. In other words, the lower portion of the locking snap-fit arrangement is positioned closer to the edge portion of the optical component holder compared to the upper portion. It should be noted that the lower portion of the locking snap-fit arrangement may be positioned above or below the upper portion of the locking snap-fit arrangement in the vertical (transversal) plane, or the upper portion and the lower portion may be arranged next to each other in a horizontal (longitudinal) plane, depending on the spatial orientation of the optical component holder. Other spatial relations between the upper and the lower portion of the locking snap-fit arrangement are conceivable.

The releasing portion may be mechanically connected to said lower portion of said locking snap-fit arrangement.

The releasing portion may be conceived as a part of the locking snap-fit arrangement body.

The at least one flexible flap may comprise a releasing portion mechanically connected to the locking snap-fit arrangement. Preferably, the releasing portion is mechanically connected to the lower portion of the locking snap-fit arrangement. The releasing portion is arranged for moving the lower portion of the locking snap-fit arrangement from the locked position to the unlocked position when it is desirable to remove the optical element. The releasing portion may be an integral part of the flexible flap. The releasing portion is preferably arranged such that it is easily accessible by the user, and such that it is maneuverable without a tool. Preferably, the releasing portion is grasped by fingers and pulled in longitudinal direction, whereupon the lower portion of the locking snap-fit arrangement is moved from the locked position to the unlocked position, such that the optical element is released and may be removed and/or replaced.

The optical component holder according to the present invention further comprises a housing connection, arranged to hold the optical component holder and the optical element attached to it within a housing of a lighting device. The housing connection is thus arranged for attaching the optical component holder to the lighting device. The housing connection is attached to the edge portion of the optical component holder and extends in the transversal plane. The housing connection comprises a locking element. The housing connection may be of any suitable kind known to a person skilled in the art.

The optical component holder further comprises a releasing element accompanied with one or more ratchet surfaces that are facing away from the central portion of the optical component holder for releasing the locking element. The at least one ratchet surface may provide snap-fitting function. The releasing element may have a locking state and unlocking state, as well, where locking state being the resting state. In the locking state of the releasing element, the at least one ratchet surface may provide snap-fitting function with the lighting device. The releasing element may be pushed in an inward direction to assume the unlocking state, wherein the inward direction being a direction substantially parallel to said longitudinal axis and towards the central portion of the central position. In this state, the releasing element may be pushed away along with the at least one rachet surface that allows releasing from the lighting device.

The releasing element may be arranged opposite to the locking element. In particular, the releasing element may be arranged at the lower portion of the locking snap-fit arrangement.

The locking snap-fit arrangement may have a dual function of releasing the optical component holder with the optical element being attached to it from the housing of the lighting device, and for releasing the optical element from the optical component holder. In this case, an inner side of the locking snap-fit arrangement that is facing the central portion may comprise the contact surface and the wedge surface, and an outer side of the locking snap-fit arrangement that is facing away from the central portion may comprise the releasing element with at least one rachet surface. The releasing element and the releasing portion may be the same in this case. Therefore, the optical component holder may offer the advantage of being simple and efficient.

The lower portion of the locking snap-fit arrangement may comprise a contact surface facing the edge portion. The lower portion of the locking snap-fit arrangement further comprises a wedge element extending substantially parallelly to the longitudinal plane and facing the central portion of the optical component holder.

The lower portion of the locking snap-fit arrangement is movable between a locked position and an unlocked position in the longitudinal plane. In the locked position, the lower portion engages with the optical element that is received by the optical component holder. On the other hand, the lower portion of the locking snap-fit arrangement is disengaged from the optical element that is held by the optical component holder in the unlocked position.

The lower portion of the locking snap-fit arrangement has a transversal cross-section being substantially parallel to the transversal plane. The transversal cross-section of the lower portion of the locking snap-fit arrangement is substantially U-shaped such that a contact angle (α) is created between the contact surface and the longitudinal plane. The term “substantially U-shaped” includes U-shaped, V-shaped, or any shape therebetween.

The contact angle (α) may be chosen from a range between 0.1 to 55 degrees. Preferably chosen between 10 to 45 degrees. The contact angle is related to the edge thickness of the optical element that is to be held into the optical component holder. The diameter of the optical component holder may be from 1 cm to 50 cm, and/or the extension of the at least one flexible flap in the transversal plane may be from 1 cm to 20 cm.

The optical component holder of the present invention operates in the following way. An optical element may be selected such that the optical element comprises a portion having a shape and size that corresponds to the shape and size of the optical component holder. The optical element may be arranged such that the portion of the optical element that is to be held by the optical component holder is aligned with the optical component holder in the proximity of the upper portion of the locking snap-fit arrangement. Further, the optical element may be moved in the direction perpendicular to the longitudinal plane of the optical component holder. During such a movement, the lower portion of the locking snap-fit arrangement is moved to the unlocked position along the longitudinal plane. The movement continues until the optical element has reached its final position, whereupon the lower portion of the locking snap-fit arrangement moves from the unlocked position to the locked position.

The contact surface of said lower portion of said locking snap-fit arrangement may comprise two contact points arranged on said contact surface.

Due to the fact that the transversal cross-section of the lower portion of the locking snap-fit arrangement is substantially U-shaped, a number of advantages may be achieved. First of all, the flexible flap may help guide the optical element into the correct position within the optical component holder. Further, the lower portion of the locking snap-fit arrangement comprises two contact points with the optical element, the contact points being arranged on the contact surface, which exert both longitudinal and transversal pressure on the optical element within the optical component holder, thus firmly and securely holding the optical element within the optical component holder. The two contact points may provide two pressure points, which may not allow rotation of optical element around a center axis of the optical component holder, where the center axis is perpendicular to the said longitudinal plane.

The upper portion of the locking snap-fit arrangement may have a first width substantially in the longitudinal plane, while the lower portion of the locking snap-fit arrangement may have a second width substantially in the longitudinal plane. The second width may be greater than the first width. The second width may be associated with the width that includes the wedge element at the lower portion of the locking snap-fit arrangement.

The flexible flap may comprise two flexible legs arranged to mechanically attach the edge portion to allow a flexible radial movement of said flexible flap.

The flexible flap may comprise two flexible legs between which the locking snap-fit arrangement is positioned. The flexible legs may mechanically connect or attach the edge portion of the optical component holder to the locking snap-fit arrangement of the flexible flap. The flexible legs may be arranged to allow a radial movement of the flexible flap.

The radial movement may be in a direction of the central portion and/or in a direction away from the central portion.

The flexible legs may be arranged such that the flexibility of the locking snap-fit arrangement is optimized. The flexible legs of the flexible flap may be rigid, i.e. devoid of flexibility, or may have lower flexibility compared to the locking snap-fit arrangement of the flexible flap. The term “lower flexibility” implies that the flexible legs of the flexible flap may move a shorter distance in the longitudinal plane compared to the distance that the locking snap-fit arrangement of the flexible flap may move.

The at least one flexible flap may be substantially M-shaped, wherein the left and right legs of the M correspond to the flexible legs of the flexible flap, and the central portion of the M corresponds to the locking snap-fit arrangement.

The releasing element may be arranged at said lower portion of said locking snap-fit arrangement that is facing away from the central portion.

The releasing element accompanied with one or more rachet surfaces may be arranged at said lower portion of said locking snap-fit arrangement that is facing away from the central portion.

The releasing element accompanied with one or more rachet surfaces may be present with the flexible flap that comprises two flexible legs arranged to mechanically attach the edge portion to allow a flexible radial movement of said flexible flap. In this case, the lower portion of the said locking snap-fit arrangement facing the central portion may or may not comprise a contact surface facing said edge portion, said lower portion of said locking snap-fit arrangement further comprising a wedge element.

The releasing element accompanied with one or more rachet surfaces may be present with the flexible flap that comprises two flexible legs may allow locking and unlocking of the optical component holder from the lighting device.

The optical component holder according to the present invention may be a single injection moulded element. Such an embodiment offers the advantage of simple and cost-efficient manufacturing of the optical component holder.

The optical component holder of the present invention may comprise a first supporting rim arranged at the edge portion of the optical component holder and extending in the transversal plane. Such a first supporting rim may be arranged in order to improve the abutment of the optical component holder to the housing of a lighting device. Further, the optical component holder may comprise a second supporting rim arranged at the edge portion of the optical component holder and extending in the longitudinal plane. Such a second supporting rim may improve the abutment of the optical element to the optical component holder.

According to a second aspect of the present invention, a lighting device is provided comprising an optical element and an optical component holder as disclosed above, wherein the optical element is releasably affixed to the optical component holder. The optical element may be a reflector comprising a reflector rim extending in the longitudinal plane. As mentioned above, the shape and size of the portion of the optical element that is to be held by the optical component holder should correspond to the shape and size of the optical component holder. In particular, the reflector may be circular, and the optical component holder may be annular. The two contact points of the locking snap-fit arrangement may be in contact with the optical element, e.g. with the reflector rim of the reflector.

The lighting device further comprises a housing, to which the optical component holder may be releasably affixed by means of the housing connection on the optical component holder. The locking element of the housing connection engages with the housing, thus firmly holding the optical component holder and the optical element within the housing. The releasing element of the housing connection should be arranged such that it is easily detectable and accessible by the user. In particular, the releasing element may be in the form of a button, by pushing which the locking element is released such that the optical component holder and the optical element may be removed from the housing. It is conceivable that the releasing element comprises an identification element, such as a color marking, an arrow, a text, or the like. In particular, the identification element may be red color and/or the text “PUSH”.

The housing may have any suitable shape and size. Indeed, the shape and size of the housing should correspond to the shape and size of the optical element, such that the optical element and the optical component holder may be inserted into the housing and may be affixed to the housing.

The lighting device of the present invention thus offers the advantage of simple and time-efficient removal and/or replacement of the optical element. The user releases the housing connection by engaging with the releasing element of the housing connection, e.g. by pushing the button, and removes the optical component holder and the optical element attached to it. Then, the user removes the optical element by engaging with the releasing portion of the optical component holder, e.g. by pulling the releasing portion in the longitudinal plane. As mentioned above, no tool is needed for such a maneuver. The lower portion of the locking snap-fit arrangement is then moved from the locked position to the unlocked position, and the optical element is removed. It should be noted that due to the flexibility of the flexible flap, the lower portion of the locking snap-fit arrangement will move from the unlocked position to the locked position once the releasing portion is unrestricted. In other words, when no optical element is attached to the optical component holder, the lower portion of the locking snap-fit arrangement will be in the locked position.

During assembly of the lighting device, the optical element is aligned with the optical component holder and pushed in the transversal plane such that the lower portion of the locking snap-fit arrangement moves from the locked position to the unlocked position, and then to the locked position again, such that the optical element is firmly fixated and centralized within the optical component holder. As mentioned above, the specific design of the lower portion of the locking snap-fit arrangement provides an improved fixation of the optical element within the optical component holder.

The optical component holder and the optical element are then inserted into the housing of the lighting device, wherein the housing connection of the optical component holder engages with the housing, such that the optical component holder and the optical element are retained within the housing.

As is evident from the above, the optical component holder of the present invention enables a quick, simple, ergonomic, and cost-efficient removal and/or replacement of an optical element.

### BRIEF DESCRIPTION OF THE DRAWINGS

Embodiments of the invention will now be described by way of example with reference to the accompanying drawings, of which:

FIG. 1 shows a perspective view of an optical component holder according to the present invention;

FIG. 2 illustrates a cross-sectional view of the optical component holder and an optical element according to the present invention;

FIGS. 3a and 3b depict a side view of the flexible flap of the optical component holder;

FIG. 4a is a cross-sectional view of the flexible flap shown in FIGS. 3a and 3b;

FIG. 4b is a top view of the flexible flap shown in FIGS. 3a and 3b;

FIG. 5 is a detailed view of the optical component holder of the present invention as well as the optical element attached to the optical component holder;

FIGS. 6a and 6b illustrate the releasing portion of the optical component holder;

FIG. 7 depicts a side view of the optical component holder with an optical element being attached to the optical component holder;

FIG. 8 shows a perspective view of the optical component holder with an optical element being attached to the optical component holder; and

FIG. 9 illustrates the lighting device comprising an optical component holder according to the present invention.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical or similar reference numerals denote the same or similar components having a same or similar function, unless specifically stated otherwise.

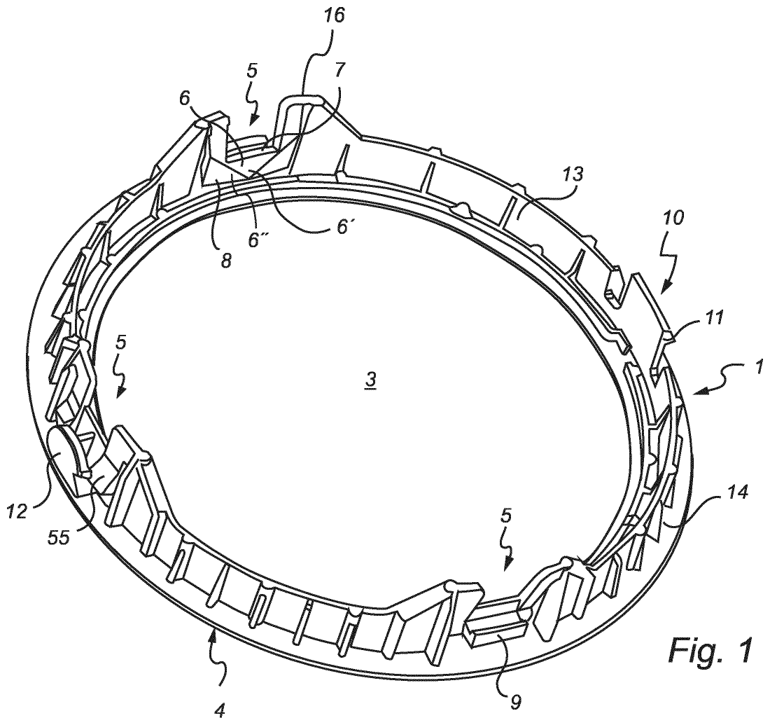

FIG. 1 illustrates an optical component holder 1 for assembling a lighting device 20. The optical component holder 1 is arranged to receive and hold an optical element 2, such as a reflector or the like, and comprises a central portion 3 and an edge portion 4, wherein the edge portion 4 delimits the central portion 3, and wherein the central portion 3 and the edge portion 4 extend substantially in a longitudinal plane. The optical component holder 1 depicted in FIG. 1 is annular.

The central portion 3 of the optical component holder 1 is constituted of an opening, and the edge portion 4 is constituted of a rim.

The optical component holder 1 comprises two flexible flaps 5 being attached to the edge portion 4 of the optical component holder 1 on the opposite sides of the edge portion 4 and extending substantially in a transversal plane being substantially perpendicular to the longitudinal plane. The flexible flaps 5 are an integral part of the optical component holder 1.

Each flexible flap 5 comprises a locking snap-fit arrangement 6. The locking snap-fit arrangement 6 is provided for releasably locking an optical element, such as a reflector, in the optical component holder, as will be illustrated below. The locking snap-fit arrangement 6 comprises a lower portion 8 being adjacent to the edge portion 4 of the optical component holder 1 and an upper portion 7 arranged at a distance from the lower portion 8 in the transversal plane. In other words, the lower portion 8 of the locking snap-fit arrangement 6 is positioned closer to the edge portion 4 of the optical component holder 1 compared to the upper portion 7. It should be noted that the lower portion 8 of the locking snap-fit arrangement 6 may be positioned above or below the upper portion 7 of the locking snap-fit arrangement 6 in the vertical plane, or the upper portion 7 and the lower portion 8 may be arranged next to each other in a horizontal plane, depending on the spatial orientation of the optical component holder 1.

The lower portion 8 of the locking snap-fit arrangement 6 is movable between a locked position and an unlocked position in the longitudinal plane. In the locked position, the lower portion 8 engages with the optical element 2 that is received by the optical component holder 1. On the other hand, the lower portion 8 of the locking snap-fit arrangement 6 is disengaged from the optical element 2 that is held by the optical component holder 1 in the unlocked position.

The lower portion 8 of the locking snap-fit arrangement 6 has a transversal cross-section being substantially parallel to the transversal plane. The transversal cross-section of the lower portion 8 of the locking snap-fit arrangement 6 is substantially V-shaped, such that a flap angle β is formed with the longitudinal plane.

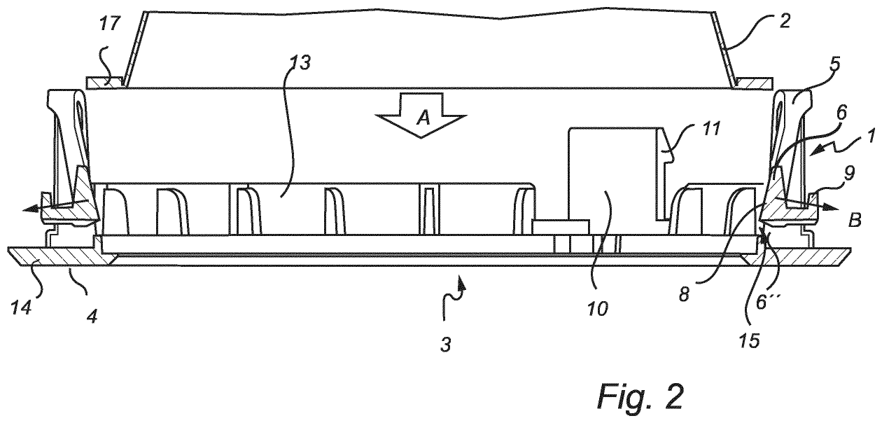

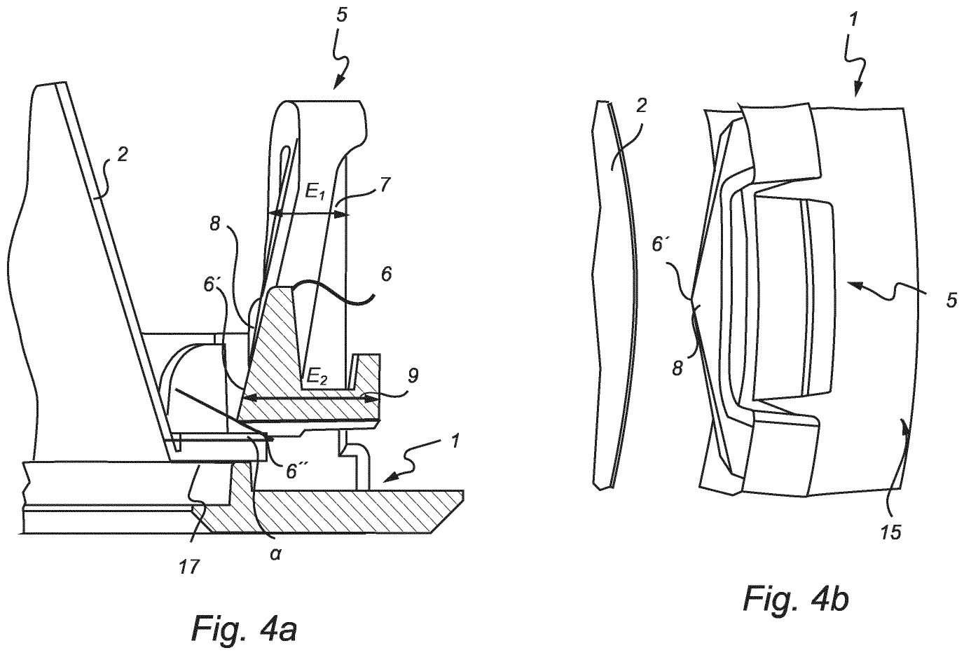

As may be seen in FIG. 1, the lower portion 8 of the locking snap-fit arrangement 6 facing the central portion 3 comprises a contact surface 6″ facing the edge portion 4. The lower portion 8 of the locking snap-fit arrangement 6 further comprises a wedge element 6′ shown in FIG. 2 and extending substantially parallelly to the longitudinal plane and facing the central portion 3 of the optical component holder 1. As depicted in FIG. 4a, a contact angle α is created between the contact surface 6″ and the longitudinal plane.

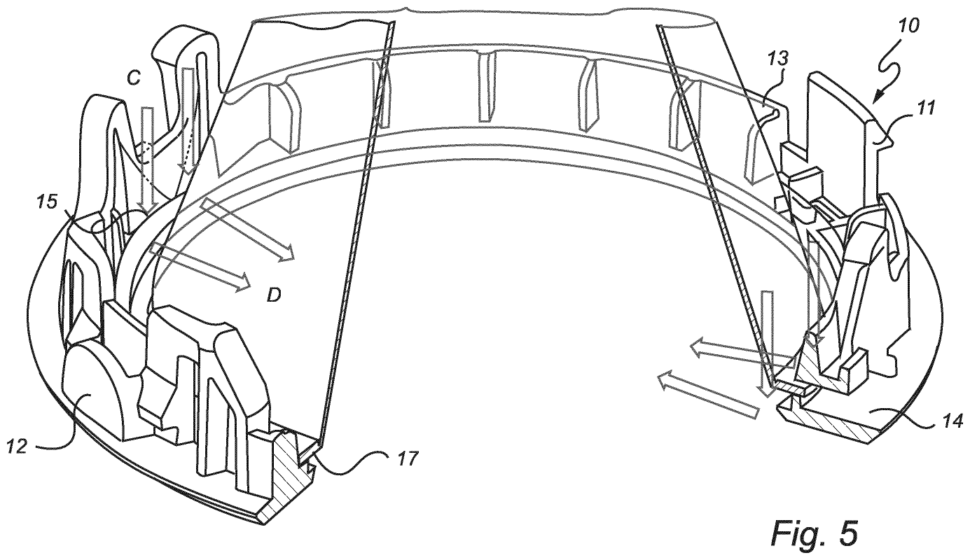

The optical component holder 1 of the present invention operates in the following way, depicted in FIG. 2. An optical element 2 is selected such that the optical element 2 comprises a portion having a shape and size that corresponds to the shape and size of the optical component holder 1. The optical element 2 is arranged such that the portion of the optical element 2 that is to be held by the optical component holder 1 is aligned with the optical component holder 1 in the proximity of the upper portion 7 of the locking snap-fit arrangement 6. Further, the optical element 2 is moved in the direction illustrated by the arrow A and being perpendicular to the longitudinal plane of the optical component holder 1. During such a movement, the lower portion 8 of the locking snap-fit arrangement 6 is moved to the unlocked position along the longitudinal plane, as shown by the arrow B. The movement continues until the optical element 2 has reached its final position, whereupon the lower portion 8 of the locking snap-fit arrangement 6 moves from the unlocked position to the locked position, as seen in FIG. 5.

Due to the fact that the transversal cross-section of the lower portion 8 of the locking snap-fit arrangement 6 are substantially V-shaped, a number of advantages is achieved. First of all, the flexible flap 5 guides the optical element 2 into the correct position within the optical component holder 1. Further, the contact surface 6″ of the lower portion 8 of the locking snap-fit arrangement 6 comprises two contact points 15 with the optical element 2, as may be seen in FIG. 5. Arrows C and D illustrate both longitudinal and transversal pressure, respectively, exerted on the optical element 2 within the optical component holder 1, thus firmly and securely holding the optical element 2 within the optical component holder 1.

The upper portion 7 of the locking snap-fit arrangement 6 has a first width E₁substantially in the longitudinal plane, the lower portion 8 of the locking snap-fit arrangement 6 has a second width E₂ substantially in the longitudinal plane, wherein the second width E₂ is greater than the first width E₁, as may be seen in FIG. 4a.

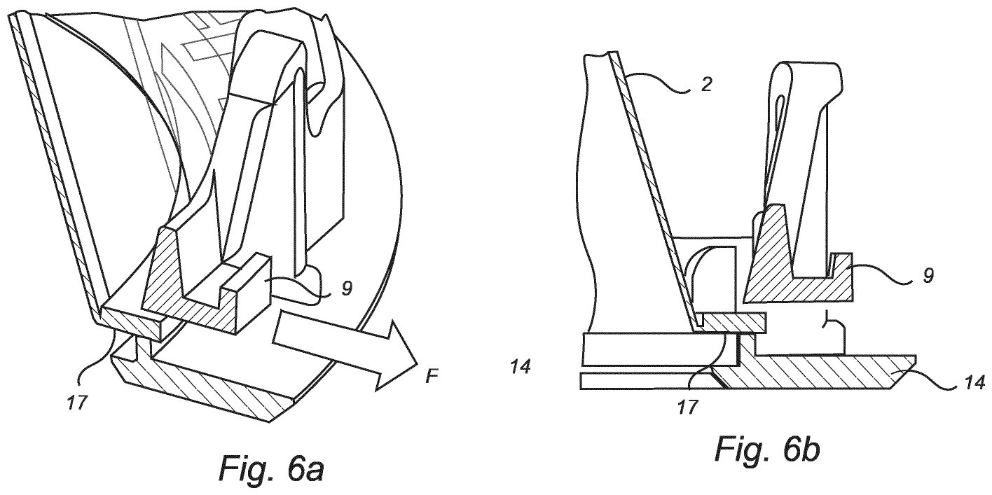

The at least one flexible flap 5 comprises a releasing portion 9 mechanically connected to the locking snap-fit arrangement 6, depicted in great detail in FIGS. 6a and 6b. The releasing portion 9 is arranged for moving the lower portion 8 of the locking snap-fit arrangement 6 from the locked position to the unlocked position when it is desirable to remove the optical element 2. The releasing portion 9 is an integral part of the flexible flap 5. The releasing portion 9 is arranged such that it is easily accessible by the user, and such that it is maneuverable without a tool. Preferably, the releasing portion 9 is grasped by fingers and pulled in longitudinal direction shown by the arrow F, whereupon the lower portion 8 of the locking snap-fit arrangement 6 is moved from the locked position to the unlocked position, such that the optical element 2 is released and may be removed and/or replaced.

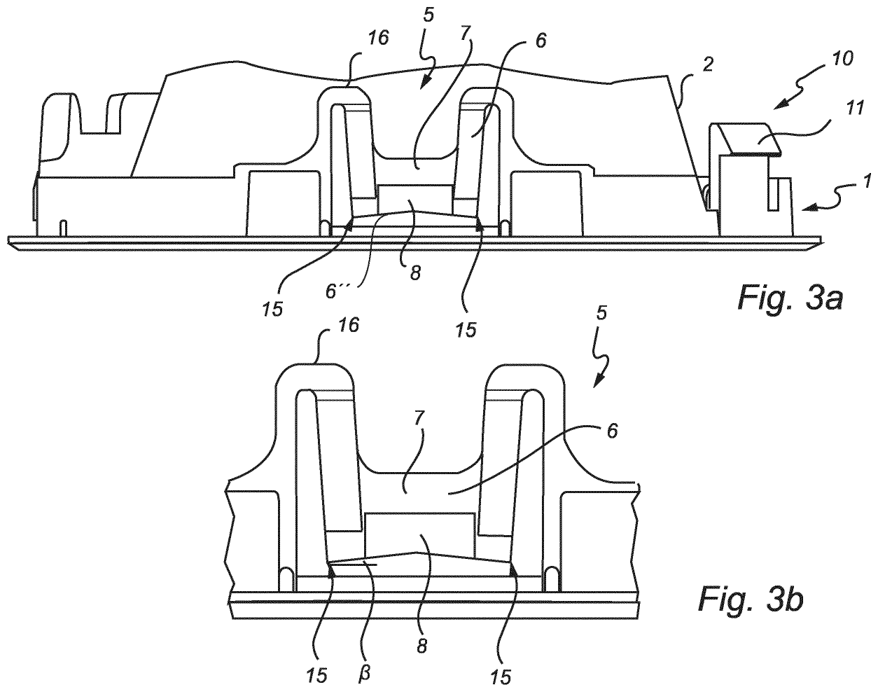

Turning the attention to FIGS. 3a and 3b, the flexible flap 5 comprises two flexible legs 16 between which the locking snap-fit arrangement 6 is positioned. The flexible legs 16 mechanically connect the edge portion 4 of the optical component holder 1 to the locking snap-fit arrangement 6 of the flexible flap 5. The flexible legs 16 are arranged such that flexibility of the locking snap-fit arrangement 6 is optimized. As may be seen in FIGS. 3a and 3b, the flexible flap 5 is substantially M-shaped, wherein the left and right legs of the M correspond to the flexible legs 16 of the flexible flap 5, and the central portion of the M corresponds to the locking snap-fit arrangement 6.

The optical component holder 1 depicted in FIG. 1 further comprises a housing connection 10, arranged to hold the optical component holder 1 and the optical element 2 attached to it within a housing 21 of a lighting device 20. The housing connection 10 comprises a locking element 11 extending in the transverse plane, and a releasing element 12 for releasing the locking element 11. The releasing element 12 comprises two ratchet surfaces 55.

The optical component holder 1 is a single injection moulded element. Such an embodiment offers the advantage of simple and cost-efficient manufacturing of the optical component holder 1.

The optical component holder 1 depicted in FIG. 1 comprises a first supporting rim 13 arranged at the edge portion 4 of the optical component holder 1 and extending in the transversal plane. Such a first supporting rim 13 is arranged in order to improve the abutment of the optical component holder 1 to the housing 21 of a lighting device 21, as depicted in FIG. 9. Further, the optical component holder 1 comprises a second supporting rim 14 arranged at the edge portion 4 of the optical component holder 1 and extending in the longitudinal plane. Such a second supporting rim 14 improves the abutment of the optical element 2 to the optical component holder 1, as depicted in FIG. 5.

FIG. 9 illustrates a lighting device 20 comprising an optical element 2 and an optical component holder 1 as disclosed above, wherein the optical element 2 is releasably affixed to the optical component holder 2. The optical element 2 may be a reflector comprising a reflector rim 17, extending in the longitudinal plane. As mentioned above, the shape and size of the portion of the optical element 2 that is to be held by the optical component holder 1 should correspond to the shape and size of the optical component holder 1. In the embodiment shown in FIGS. 1-9, the reflector 2 is circular, and the optical component holder 1 is annular. The two contact points 15 of the locking snap-fit arrangement 6 are in contact with the optical element 2, e.g. with the reflector rim 17 of the reflector 2, as seen in FIG. 5.

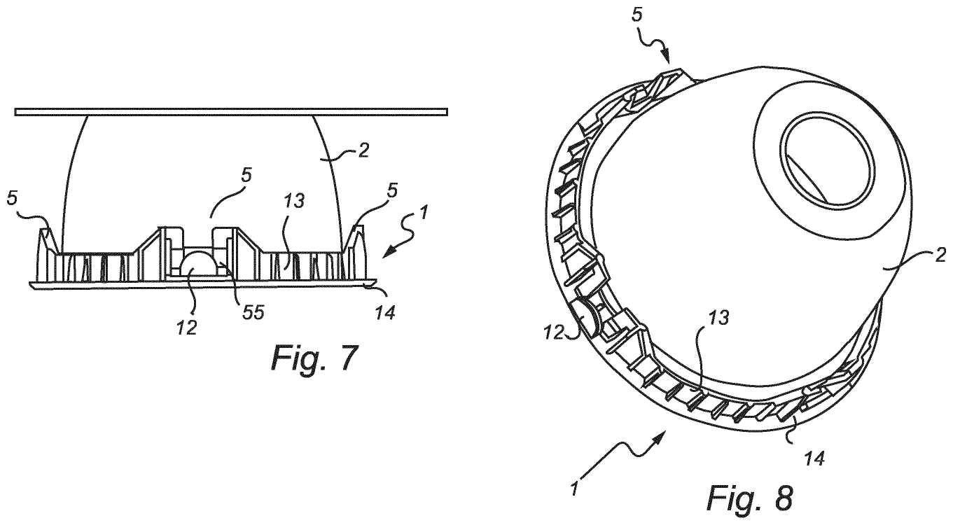

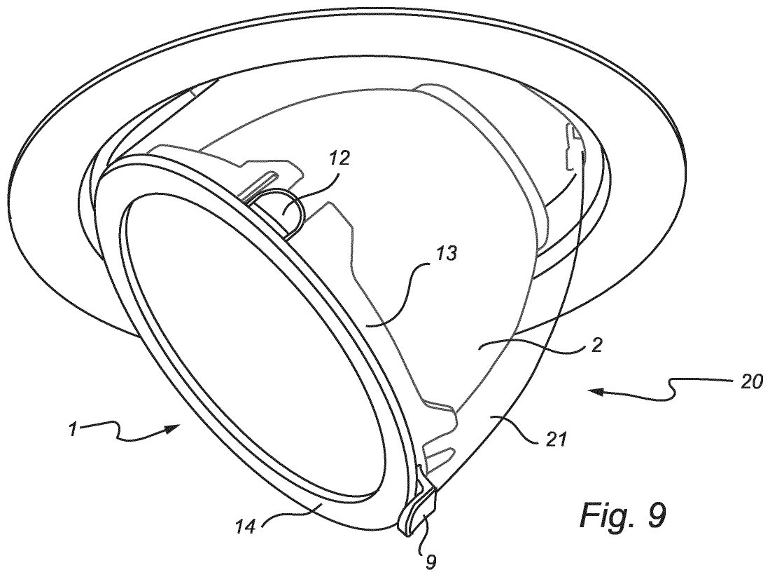

The lighting device 20 further comprises a housing 21, to which the optical component holder 1 may be releasably affixed by means of the housing connection 10 on the optical component holder 1. The locking element 11 of the housing connection 10 engages with the housing 21, thus firmly holding the optical component holder 1 and the optical element 2 within the housing 21. The releasing element 12 of the housing connection 10 should be arranged such that it is easily detectable and accessible by the user. As may be seen in FIGS. 7 and 8, the releasing element 12 is in the form of a button, by pushing which the locking element 11 is released such that the optical component holder 1 and the optical element 2 may be removed from the housing 21.

The lighting device 20 of the present invention thus offers the advantage of simple and time-efficient removal and/or replacement of the optical element 2. The user releases the housing connection 10 by engaging with the releasing element 12 of the housing connection 10, e.g. by pushing the button, and removes the optical component holder 1 and the optical element 2 attached to it. Then, the user removes the optical element 2 by engaging with the releasing portion 9 of the optical component holder 1, e.g. by pulling the releasing portion 9 in the longitudinal plane in the direction of the arrow F in FIG. 6a. As mentioned above, no tool is needed for such a maneuver. The lower portion 8 of the locking snap-fit arrangement 6 is then moved from the locked position to the unlocked position, and the optical element 2 is removed. It should be noted that due to the flexibility of the flexible flap 5, the lower portion of the locking snap-fit arrangement 6 will move from the unlocked position to the locked position once the releasing portion 9 is unrestricted. In other words, when no optical element 2 is attached to the optical component holder 1, as shown in FIG. 1, the lower portion 8 of the locking snap-fit arrangement 6 will be in the locked position.

During assembly of the lighting device 20, the optical element 2 is aligned with the optical component holder 1 and pushed in the transversal plane in the direction A shown in FIG. 2, such that the lower portion 8 of the locking snap-fit arrangement 6 moves from the locked position to the unlocked position, and then to the locked position again, such that the optical element 2 is firmly fixated and centralized within the optical component holder 1. As mentioned above, the specific design of the lower portion 8 of the locking snap-fit arrangement 6 provides an improved fixation of the optical element 2 within the optical component holder 1.

The optical component holder 1 and the optical element 2, depicted in FIGS. 7 and 8, are then inserted into the housing 21 of the lighting device 20, wherein the housing connection 10 of the optical component holder 1 engages with the housing 21, such that the connection device 1 and the optical element 2 are retained within the housing 21, as shown in FIG. 9.

As is evident from the above, the optical component holder 1 of the present invention enables a quick, simple, ergonomic, and cost-efficient removal and/or replacement of an optical element 2.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention. While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An optical component holder for assembling a lighting device, said optical component holder comprising:
a central portion and an edge portion, wherein said edge portion delimits said central portion, and wherein said central portion and said edge portion extend substantially in a longitudinal plane;
at least one flexible flap being attached to said edge portion of said optical component holder and extending substantially in a transversal plane being substantially perpendicular to said longitudinal plane, said at least one flexible flap comprising a locking snap-fit arrangement, wherein said locking snap-fit arrangement comprises a lower portion being adjacent to said edge portion of said optical component holder, an upper portion arranged at a distance from said lower portion in said transversal plane, said locking snap-fit arrangement further comprising a releasing portion;
a housing connection being arranged for attaching said optical component holder to said lighting device, said housing connection being attached to said edge portion of said optical component holder and extending in said transversal plane and comprising a locking element;
a releasing element accompanied with one or more ratchet surfaces that are facing away from said central portion of said optical component holder for releasing said locking element;
wherein at least one flexible flap has a lower portion of said locking snap-fit arrangement that comprises a contact surface facing said edge portion, said lower portion of said locking snap-fit arrangement further comprising a wedge element extending substantially parallelly to said longitudinal plane and facing said central portion of said optical component holder, said lower portion of said locking snap-fit arrangement being movable between a locked position and an unlocked position in said longitudinal plane, said lower portion of said locking snap-fit arrangement having a transversal cross-section being substantially parallel to said transversal plane,
wherein said transversal cross-section of said lower portion of said locking snap-fit arrangement is substantially U-shaped, and
wherein between said contact surface and said longitudinal plane, a contact angle is created that is an acute angle.

2. The optical component holder according to claim 1, wherein said releasing portion is mechanically connected to said lower portion of said locking snap-fit arrangement.

3. The optical component holder according to claim 1, wherein said contact surface of said lower portion of said locking snap-fit arrangement comprises two contact points arranged on said contact surface.

4. The optical component holder according to claim 1, wherein said contact angle is chosen from a range between 0.1 to 55 degrees.

5. The optical component holder according to claim 1, wherein said releasing element is substantially opposite to said locking element.

6. The optical component holder according to claim 1, wherein said flexible flap comprises two flexible legs arranged to mechanically attach the edge portion to allow a flexible radial movement of said flexible flap.

7. The optical component holder according to claim 1, wherein said releasing element is arranged at said lower portion of said locking snap-fit arrangement facing away from the central portion.

8. The optical component holder according to claim 1, wherein said upper portion of said locking snap-fit arrangement has a first width substantially in said longitudinal plane, said lower portion of said locking snap-fit arrangement has a second width substantially in said longitudinal plane, wherein said second width is greater than said first width.

9. The optical component holder according to claim 1, wherein said optical component holder is a single injection moulded element.

10. The optical component holder according to claim 1, wherein said optical component holder further comprises a first supporting rim arranged at said edge portion of said optical component holder and extending in said transversal plane.

11. The optical component holder according to claim 1, wherein said optical component holder comprises a second supporting rim (arranged at said edge portion of said optical component holder and extending in said longitudinal plane.

12. The optical component holder according to claim 1, wherein said at least one flexible flap is substantially M-shaped.

13. The optical component holder according to claim 1, wherein said at least one optical component holder is substantially annular.

14. The optical component holder according to claim 8, wherein the diameter of said optical component holder is chosen from 1 cm to 50 cm, and/or wherein said first width and/or said second width of said at least one flexible flap in said transversal plane is chosen from 1 cm to 20 cm.

15. A lighting device comprising an optical element, a housing, and an optical component holder according to claim 1, wherein said optical element is releasably affixed to said optical component holder, and wherein said optical component holder is releasably affixed to said housing.
